(19) United States
(12) Patent Application Publication
(10) Pub. No.: US 2012/0227313 A1
(43) Pub. Date: Sep. 13, 2012

(54) CRAWLING INSECT (BED BUG AND MITE) ABATEMENT SYSTEM AND METHOD

(75) Inventors: Michael M. Mozeika, III, Brick, NJ (US); Timothy Croll, Boothwyn, PA (US); Jonathan Wang, Wayne, PA (US); Kenneth Overk, Deptford, NJ (US)

(73) Assignee: FXI, Inc., Media, PA (US)

(21) Appl. No.: 13/404,209

(22) Filed: Feb. 24, 2012

Related U.S. Application Data
(60) Provisional application No. 61/451,812, filed on Mar. 11, 2011.

(51) Int. Cl. A01M 1/20; A01M 1/10

(52) U.S. Cl. 43/121; 43/132.1

(57) ABSTRACT

A crawling insect abatement matrix, system and method includes a cellular, nonwoven, wet laid or fibrous substrate with a shaped surface to which diatomaceous earth (diatomite, kieselgur, amorphous silica) particles are bound, either in situ or with a binder/coating applied to the substrate. A representative cellular substrate is polyurethane foam with a convoluted or otherwise shaped surface to which a coating that includes diatomaceous earth particles has been applied. The substrate is formed as a sheet, mat or pad that may be installed between a mattress and bedding structure or bedding textiles or below furniture articles, or in clothing compartments, or formed as a tape that may be applied to a surface of a mattress, a bedding structure, a headboard, bedding textiles, or to a clothing compartment.

### CROSS-REFERENCE TO RELATED APPLICATION

This application claims priority under 35 USC 119(e) from U.S. Ser. No. 61/451,812, filed Mar. 11, 2011.

### FIELD OF THE INVENTION

The present invention relates to sheets, mats, pads and tapes formed of a polyurethane foam matrix, nonwoven synthetic fiber matrix or other cellular matrix that has either a surface coating that contains diatomaceous earth (amorphous silica) or to which diatomaceous earth is adhered, or a formulation with diatomaceous earth in situ.

### BACKGROUND

Bed bugs (“cimex lectularis”) are insects that hide within bed mattresses and within cracks and crevices of headboards or other bedding support structures. At night, bed bugs feed on the blood of persons sleeping on mattresses/bedding that harbor the insects.

Once bed bugs have infested a mattress or bedding support structure, they are difficult to eliminate/exterminate. The U.S. Environmental Protection Agency identifies many non-chemical and chemical treatment methods to control bed bugs, such as: vacuuming to remove debris in harborages; applying desiccant dusts such as diatomaceous earth to mattresses, baseboards and cracks and crevices; drying bedding in heated clothes dryers; heating a portion of or the entire room or heating or steaming the bedding; freezing bed bugs on surfaces; and applying liquid or aerosol chemical insecticides or pesticides.

In one method to eliminate bed bugs and other mites, miticides, insecticides or chemical pesticides containing mixtures of chemical substances are sprayed onto and around infested surfaces. In U.S. Pat. Appln. 2008/035134, a bedding cover is treated with a pyrethrin-containing pesticide to repel or kill bed bugs, dust mites ticks and fleas. U.S. Pat. No. 6,440,438 discloses furniture and bed covers impregnated with an insecticide, such as permethrin. Conventional miticides and pesticides are highly toxic, and spraying such toxins poses health risks to humans and pets.

In another method, bed bugs and other insects are captured with tacky adhesive surfaces or reservoirs. U.S. Pat. No. 1,464,397 describes a bed frame with a groove to hold a vermin barrier paste. U.S. Pat. No. 7,676,985 shows a molding strip having an internal crevice with adhesive disposed also on the inside portion to catch insects, including bed bugs. See also, U.S. Pat. No. 4,217,722 for an adhesive membrane insect trap.

In yet another method, bed bugs and mites are captured using attractants. In U.S. Pat. No. 6,415,545, an attractant miticide and capturing device has a padding sheet that has been sprayed with an attractant miticide, and optionally with a food attractant and an aromatic attractant. The padding sheet is inserted into a capturing pouch formed from a fabric, such as a towel or knitted fabric. As an alternative, the padding sheet may be a central portion of a mat, with the exterior mat fabric surface pierced to form holes through which the insects enter the mat. The pouch or mat may be installed under a bed or under a mattress or in other places within a home.

The industry continues to seek improvements and safe and effective alternatives for repelling crawling insects, trapping crawling insects and abating crawling insect infestations. “Crawling insects” herein is intended broadly to include bed bugs, mites, fleas, earwigs, beetles, box elder bugs, cockroaches, German cockroaches, crickets, ants, fire ants, spiders, scorpions, silverfish, among others.

### SUMMARY OF THE INVENTION

In a first aspect of the invention, a crawling insect abatement matrix may be a cellular, nonwoven, wet laid or other fibrous substrate with at least one shaped surface having at least one valley or trough into which diatomaceous earth particles are bound or adhered or held. An example of a cellular substrate is a foam, such as an open cell polyurethane foam or an open cell reticulated polyurethane foam with pore sizes in the range of about 5 pores per inch (ppi) to about 90 ppi, more preferably about 40 ppi to about 75 ppi. An example of a nonwoven substrate is a staple or spunlaid nonwoven or felt of synthetic fibers. An example of a wet laid or other fibrous substrate is wet laid or blown wood pulp. The substrate may be shaped into a mat, pad, sheet or tape with substantially flat top and bottom surfaces, or may be shaped into a mat, pad, sheet or tape with at least one shaped or convoluted surface comprising multiple peaks, projections or raised portions separated by multiple valleys or troughs therebetween.

The diatomaceous earth particles may be mixed with one or more binders and then coated (sprayed, dipped, painted) onto at least one surface of the substrate. The coating/binder with diatomaceous earth particles may be applied solely on the substrate surface in the valley(s) or trough(s), or may be applied to cover the entire surface. Alternatively, a coating/binder may be applied to at least one surface of the substrate and the diatomaceous earth particles may be sprinkled or otherwise applied to be held thereby. As still another alternative, the diatomaceous earth particles may be incorporated in situ as one ingredient in a formulation producing a foam or fibers.

In a second aspect of the invention, the abatement matrix forms part of a system for abating crawling insects.

In a third aspect of the invention, a method for abating crawling insects installs the abatement matrix onto or below a bedding surface, or below a furniture article. The matrix may be in sheet, mat or pad form, and such sheet, mat or pad may be installed between a bedding mattress and a box spring or bedding support structure, or the matrix in sheet, mat or pad form may be installed between a bedding mattress and a bed pad, mattress topper, bed sheet or other textile bedding. Alternatively, the matrix may be in tape form, with at least one adhesive surface. The matrix in tape form may be applied to a surface of the bedding mattress, bed pad, mattress topper, bed sheet, bedding support surface, bed frame or headboard. Multiple such tapes may be applied at multiple locations.

In a fourth aspect of the invention, a method for abating crawling insects installs the abatement matrix inside a clothing storage compartment, such as in luggage, in a duffle, in a wardrobe, in a dresser, in a cabinet, and/or in a drawer.

### DESCRIPTION OF THE DRAWINGS

The advantages of this invention will be more readily apparent from the following description of the drawings in which:

FIG. 1A is a perspective view of a polyurethane foam sheet of a medium to coarse cell pore size onto which a surface coating of binder mixed with diatomaceous earth has been applied;

FIG. 1B is a perspective view, partially cut away, of a polyurethane foam sheet of medium to coarse cell pore size that has been impregnated with a coating of binder mixed with diatomaceous earth;

FIG. 2 is a perspective view of a polyurethane foam sheet of a medium to coarse cell pore size with a surface shaped by convolute projections onto which a surface coating of binder mixed with diatomaceous earth has been applied;

FIG. 3 is a perspective view of a polyurethane foam sheet of a medium to coarse cell pore size with an alternative shaped surface onto which a surface coating of binder mixed with diatomaceous earth has been applied;

FIG. 4 is a perspective view of a polyurethane foam sheet of a medium to coarse cell pore size with a surface shaped by convolute projections and onto which a surface coating of a binder is applied and onto which diatomaceous earth particles have been sprinkled;

FIG. 5 is a perspective view of a crawling insect abatement system installed between a box spring and bedding mattress; and

FIG. 6 is a perspective view of a crawling insect abatement system installed within a suitcase.

### DESCRIPTION OF THE PREFERRED EMBODIMENTS

A crawling insect abatement system includes a porous matrix in which diatomaceous earth is incorporated in situ, or onto which a coating containing diatomaceous earth is applied. The porous matrix may be a foam, a nonwoven of natural or synthetic fibers, a wet laid batting or a fibrous formed structure or a cellular structure. Suitable foams for the matrix include, but are not limited to, open cell polyurethane, reticulated polyurethane, polyolefin, melamine, silicone or cellulosic foams. Suitable nonwovens for the matrix include, but are not limited to, staple or spunlaid nonwovens or felts of polyamide, polyethylene terephthalate (PET) and/or polypropylene (PP) fibers, or compressed fibers or felts, such as produced by Filtrona plc (“Fibertec”). Suitable wet laid materials for the matrix include wood pulps and other fibrous pulps.

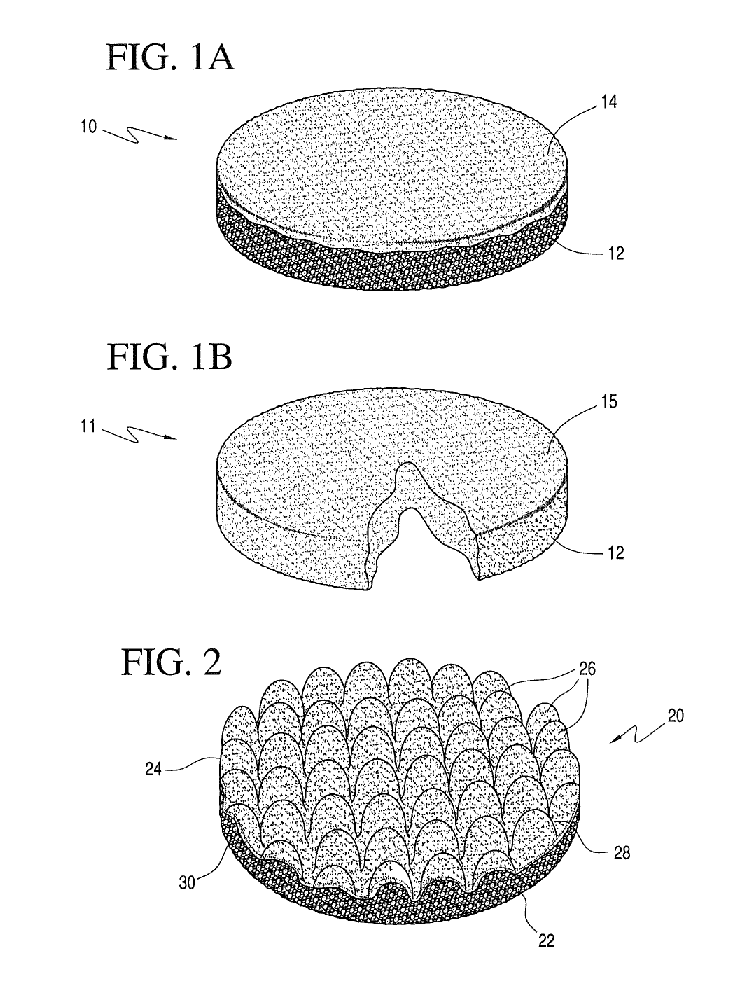

Referring first to FIG. 1A, a first embodiment of a crawling insect abatement system 10 is a sheet 12 of open cell reticulated polyurethane foam having a medium cell size that is coated with a coating 14 of a binder containing diatomaceous earth. FIG. 1B shows a crawling insect abatement system 11 that is a foam sheet 12 with a diatomaceous earth containing binder 15 impregnated throughout the thickness of the foam. Impregnation may be performed, for example, by dipping the foam into a liquid binder and squeezing excess binder by passing the wetted foam through a nip between compression rollers.

Foams with a fine pore size have pore sizes in the range of about 70 to about 110 pores per inch (ppi). Foams with a coarse pore size have pore sizes in the range of 3 to about 40 ppi. Foams with a medium pore size have pore sizes generally in the range of about 40 to about 70 ppi.

Polyurethane foams are generally prepared by the reaction of one or more active hydrogen-containing compounds (i.e, polyether or polyester polyols) and one or more polyisocyanates, in the presence of a blowing agent such as water, and usually at least one reaction catalyst and foam stabilizer. The cellular polymer structure of polyurethane foam has a skeletal framework of relatively heavy strands forming an outline for the cell structure. The skeletal framework strands are connected by very thin membranes, often called windows, which form the cell walls. In open-celled foams, some of the windows are open or torn in each cell, thus forming an interconnecting network open to fluid flow (liquid or gas).

A reticulated foam is produced by removing the cell windows from the cellular polymer structure, leaving a network of strands and thereby increasing the fluid (liquid or gas) permeability of the resulting reticulated foam. Foams may be reticulated by in situ, chemical or thermal methods, all as known to those of skill in foam production. As one example, foam may be reticulated by melting the windows with a high temperature flame front or explosion, which still leaves the strand network intact. Alternatively, the cell windows may be etched away using the hydrolyzing action of water in the presence of an alkali metal hydroxide. See U.S. Pat. Nos. 3,125,542; 3,405,217; 3,423,338; 3,425,890 and 4,670,477 for descriptions of various reticulating methods for polyurethane foams.

The foam-forming process may be carried out batch-wise, semi-continuously or continuously. In a continuous foam-forming process, the components are concurrently introduced to a mixing head and mixed together to cause a foaming reaction. Extra air or carbon dioxide may be incorporated into the mixture at the mix head to control the foam cell diameter in the resulting foam. The mixture is then introduced into an open container or onto a moving conveyor to permit free rise expansion of the foam. Preferably, the free rise expansion is carried out under ambient temperature and pressure, but foaming under controlled pressure and temperature conditions is still within the scope of the free rise foaming intended with the present inventive method. The foaming mixture is allowed to rise and cure. The cured foam has pore sizes in the range of 3 to 110 ppi, preferably 40 to 75 ppi, and more particularly about 45 ppi.

After the foam has cured, preferably under ambient conditions for at least 12 hours, preferably at least 24 hours, it may be fabricated into a sheet, mat, pad or a shaped part or tape. The foam slab formed on a moving conveyor may be cut to smaller pieces for further processing. The foam may be shaped by a number of different methods known to persons skilled in the art, including slicing, die cutting, grinding, peeling, machining, convoluting, embossing, laser cutting, water pressure cutting or other shaping by cutting or any combination of these fabrication techniques, to form a sheet, mat, pad or shaped part or tape.

In FIG. 2, a second embodiment is a crawling insect abatement system 20 having a reticulated foam sheet 22 that has a shaped upper surface 24 with a series of peaks 26 separated by valleys 28, such as may be formed by convolute cutting. The shaped upper surface 24 is coated with a coating 30 formed of a binder that contains diatomaceous earth particles. Alternatively, the binder may be impregnated through the thickness of the foam sheet.

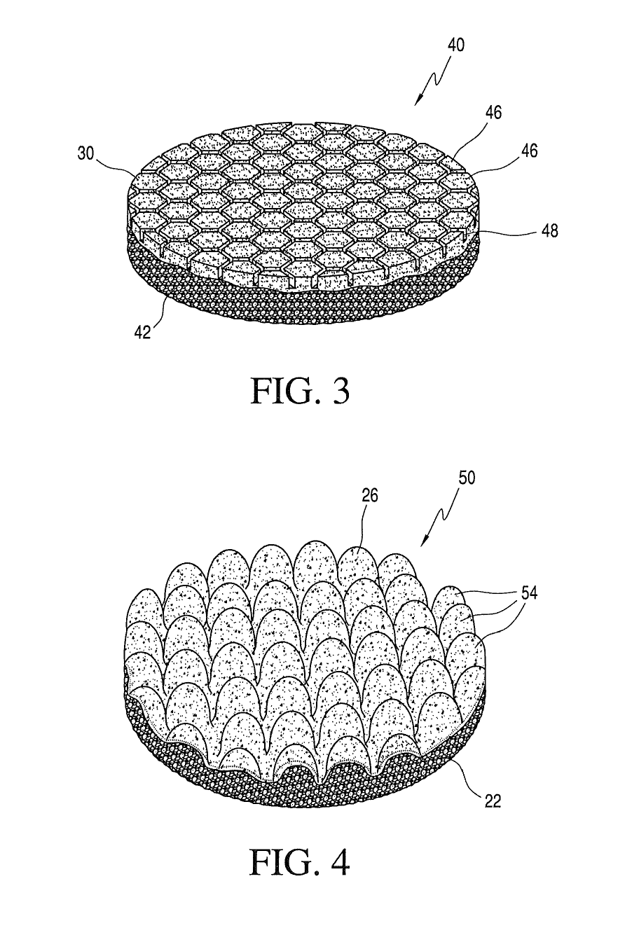

In FIG. 3, a third embodiment is a crawling insect abatement system 40 having a foam sheet 42 with a shaped upper surface with a series of honey-comb shaped projections 46 separated by troughs or valleys 48, such as may be formed by surface modification technology cutting. The shaped upper surface is coated with a coating 30 formed of a binder that contains diatomaceous earth particles. Alternatively, the binder may be impregnated through the thickness of the foam sheet.

Matrixes with shaped surfaces increase the surface area on which diatomaceous earth may be present, and also form attractive harborages for crawling insects, particularly bed bugs. Thus, a crawling insect abatement matrix with a shaped surface, such as one with valleys or troughs between peaks or raised projections, creates reservoirs or harborages in the valleys or troughs that attract the crawling insects. For matrixes with shaped surfaces (as compared to those with flat surfaces) the crawling insects traverse more of the diatomaceous earth treated surface due to the greater surface area over which the insect crawls. Moreover, the valleys or troughs of a shaped surface also hold diatomaceous earth particles therein, causing the crawling insect to be exposed to this natural pesticide for longer durations while such insect harbors in such a valley or trough.

Diatomaceous earth particles may be added to the foam-forming mixture in situ. The diatomaceous earth may be added in amounts from 0.1 to 50 parts per hundred parts polyol, preferably about 20 parts per hundred parts polyol. Such filled foam may form the matrix of the crawling insect abatement system. At least some of the diatomaceous earth particles remain in tact in the foam, and have at least some sharp surfaces exposed to contact insects that traverse onto the crawling insect abatement system formed with such foam.

Alternatively, the porous matrix is coated or impregnated with a coating comprising a binder to which diatomaceous earth particles are added or onto which diatomaceous earth particles are applied. In one embodiment, the coating is applied onto the surface within the trough(s) or valley(s) of the substrate. In another embodiment, the coating is applied over the entire shaped surface. In yet another embodiment, the coating is impregnated through the thickness of the porous matrix. In still another embodiment, the diatomaceous earth particles are applied to the surface of the substrate and held within the trough(s) or valley(s) without a coating or binder.

Various binders suitable for adhering to cellular materials, such as foams, reticulated foams, non-wovens and textiles are suitable. The coating binder may be an acrylic emulsion polymer binder, such as ACRYGEL offered by Omnova Solutions, S77 offered by 3M, or RHOPLEX offered by Dow Chemical/Rohm and Haas. Such coating containing diatomaceous earth particles may be sprayed onto the surface of the matrix, or may be applied by other coating methods, such as dipping, dipping and nipping, or painting. When incorporated into the binder, the diatomaceous earth particles may be present in amounts preferably up to 50% by weight, more preferably about 10 to 30% by weight, most preferably about 20% by weight. Alternatively, a binder may be applied to the surface of the matrix, and before the binder has cured, diatomaceous earth particles may be sprinkled or spread over the matrix surface. In such manner, the diatomaceous earth particles are bound to or adhered to the surface of the porous matrix. More of the sharp edges of the diatomaceous earth may be left intact and exposed for contacting crawling insects using this alternative binding method.

Such coatings may be applied at a desired coating thickness onto a surface or may be impregnated throughout the thickness of the matrix. Coating thicknesses on the matrix surface from 0.01 to 4 mm have proven satisfactory.

FIG. 4 shows a fourth embodiment of a crawling insect abatement system 50 with a shaped surface with projections 26 and coated with a binder or coating onto which the diatomaceous earth particles 54 were sprinkled or spread after the coating was applied.

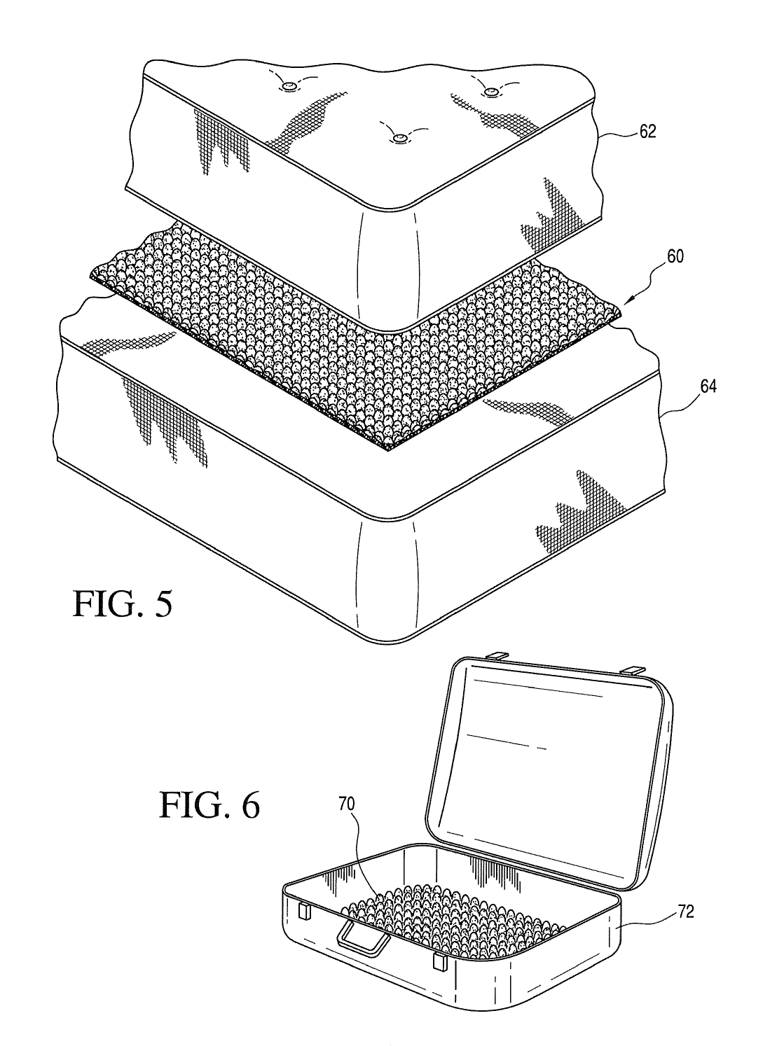

The matrix with diatomaceous earth particles therein or coated thereon or otherwise held thereon may be formed into a sheet, pad or mat that may be inserted between the bedding mattress and the box spring or between the bedding mattress and a mattress pad. As shown in FIG. 5, the crawling insect abatement system 60 is a rectangular mat that has been installed between the box spring 64 and bed mattress 62. Alternatively, the crawling insect abatement system may be installed below a bedding surface or below the bed support. As yet another alternative, the crawling insect abatement system may be installed inside or under furniture adjacent to a bed, such as a nightstand, bureau, wardrobe, dresser, and the like.

In another embodiment, the matrix with diatomaceous earth particles therein or coated thereon or otherwise held thereon may be formed into a strip that may be inserted into a gap between a bedding headboard and mattress or a bedding support structure. In yet another embodiment, the matrix with diatomaceous earth particles therein or coated thereon or otherwise held thereon may be formed into an adhesive strip or tape that may be adhered to a mattress, a bedding headboard or a bedding support structure.

In yet another embodiment, a crawling insect abatement system may be formed as a mat or sheet that may be installed within a clothing storage compartment, such as luggage, a duffle, a wardrobe, a dresser, a cabinet and/or a drawer. Referring to FIG. 6, the crawling insect abatement system 70 is a rectangular mat that has been installed within a luggage compartment 72. As one example, such a mat may have dimensions of 10 inch width, by 15 inch length, by 0.25 to 0.5 inch thickness

When formed as an adhesive strip or tape, one surface, such as a surface opposite from the diatomaceous earth coated surface if diatomaceous earth is only coated on one surface, bears an adhesive. Adhesives may include pressure sensitive adhesive compositions, such as adhesives based on styrene block copolymers, ethylene vinyl acetate copolymers, nitriles and rubbers. The adhesive surface may be covered by a release sheet, paper or foil.

Diatomaceous earth (amorphous silica, diatomite, kieselgur) is a natural pesticide that does not harm mammals. The diatomaceous earth particles have sharp edges that cut the waxy exoskeleton of crawling insects, such as bed bugs and other mites, causing dehydration over time. Diatomaceous earth particles preferably have particle sizes in the range of 10 to 200 microns.

If polyurethane foam is selected as the matrix, preferably the foam has a density in the range of 1.0 to 2.0 pounds per cubic foot, and a compression force deflection (CFD₂₅) in the range of 0.1 to 0.5 psi. A system incorporating such foams resists excessive compression so as to maintain sufficient porous character to be an attractive surface and hiding region for bed bugs and mites.

### EXAMPLES

### Example 1

A polyurethane foam is made in a hand mix with the following composition:

| | | |
|---|---|---|
| Polyol 3139 | 100 | parts |
| Surfactant SE232 | 1.4 | parts |
| Blowing Agent/Water | 4.6 | parts |
| Catalyst K5N | 0.3 | parts |
| Catalyst C-124 | 0.7 | parts |
| Surfactant L-6202 | 1.0 | parts |
| Color Rebus 2101 | 5.7 | parts |
| Isocyanate TD80 | 42.4 | parts |
| Isocyanate TD65 | 19.2 | parts |
| Isocyanate Index | 122 | |

Polyol 3139 is available from Dow Voranol. Tin catalyst K5N is available from Evonik. Amine catalyst C-124 is available from Niax Momentive. Surfactant L-6202 is available from Niax Momentive. Color Rebus 2101 is available from Rebus/Milliken. TD80 is a toluene diisocyanate mixture comprised of 80 percent 2,4-toluene diisocyanate and 20 percent 2,6-toluene diisocyanate. TD65 is a toluene diisocyanate mixture comprised of 65 percent 2,4-toluene diisocyanate and 35 percent 2,6-toluene diisocyanate. The parts are expressed as per 100 parts polyol.

The mixed ingredients are poured into a 15″×15″ square cardboard box and allowed to cure at room temperature and atmospheric pressure. The cured foam is then thermally reticulated.

The reticulated foam is then cut to sheets of thickness from ¼ to ½ inch and spray coated on one surface with a binder composition:

| | |
|---|---|
| Ammonia | 8.0% |
| Water | 52.4% |
| Binder Rhoplex TR934 | 15.0% |
| Defoamer BYK 020 | 0.8% |
| Thickener 50% ASE 60 Premix | 3.8% |
| Diatomaceous Earth | 20.0% |

The percentages are expressed as percentages by weight. The diatomaceous earth is Diatom Dust XR from Tallman Scientific. The defoamer is from BYK. The binder and thickener are from Dow Rohm and Haas. The coating thickness is less than 1 mm.

### Example 2

The reticulated foam of Example 1 is cut to sheets of thickness from ¼ to ½ inch and spray coated with a binder composition comparable to Example 1, except that one half of the diatomaceous earth is replaced with talc powder.

### Example 3

A polyurethane foam is made in a hand mix with the following composition:

| | | |
|---|---|---|
| Polyol 3139 | 100 | parts |
| Surfactant L620 | 1.0 | parts |
| Blowing Agent/Water | 4.6 | parts |
| Catalyst K29 | 0.5 | parts |
| Catalyst C-124 | 1.4 | parts |
| Diatomaceous Earth | 20.0 | parts |
| Isocyanate TD80 | 59.7 | parts |
| Isocyanate Index | 122 | |

Polyol 3139 is available from Dow Voranol. Tin catalyst K29 is available from Evonik. Amine catalyst C-124 is available from Niax Momentive. Surfacant L-620 is available from Niax Momentive. TD80 is a toluene diisocyanate mixture comprised of 80 percent 2,4-toluene diisocyanate and 20 percent 2,6-toluene diisocyanate. The diatomaceous earth is Diatom Dust XR from Tallman Scientific. The parts are expressed as per 100 parts polyol.

The mixed ingredients are poured into a 15″×15″ square cardboard box and allowed to cure at room temperature and atmospheric pressure. The cured foam is then thermally reticulated. The reticulated foam of Example 3 is cut to sheets of thickness from ¼ to ½ inch.

### Example 4

The surface of the foam sheet of Example 1 is shaped or contoured to form peaks and valleys, such as by convoluting, before the binder composition is sprayed onto the contoured surface. The peak heights as measured from the top of a peak to the base of the valley are about ¾ to about 3/16 inch. The coating thickness is less than 1 mm.

Sheets of the coated foams of Examples 1, 2 and 4 and the in situ diatomaceous earth containing foam of Example 3 are placed into a closed chamber containing a population of bed bugs, and are exposed to the sheets for exposure times of up to 24 hours. The bed bug populations are then observed 1 day, 3 days, 7 days and 14 days after the exposure. At longer exposure times (particularly 24 hours), the bed bug populations are decreased by one half to up to 80% when the bed bugs are exposed to the treated foams. The surface-contoured foam (Example 4) with sprayed diatomaceous earth binder coating outperforms the other foams.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

We claim:

1. A crawling insect abatement matrix, comprising:
a cellular, nonwoven, wet laid or other fibrous substrate with at least one shaped surface having at least one valley or trough into which diatomaceous earth particles are bound or adhered or held.

2. The crawling insect abatement matrix of claim 1, wherein the substrate comprises a polyurethane foam or a reticulated polyurethane foam.

3. The crawling insect abatement matrix of claim 2, wherein the foam has pores with pore sizes in the range of about 40 ppi to about 75 ppi.

4. The crawling insect abatement matrix of claim 1, further comprising one or more binders into which the diatomaceous earth particles are mixed, and wherein said binder is coated onto the at least one shaped surface of the substrate.

5. The crawling insect abatement matrix of claim 4, wherein the coating thickness is from 0.01 to 4 mm.

6. The crawling insect abatement matrix of claim 1, further comprising one or more coatings on the at least one shaped surface and to which diatomaceous earth particles are applied to be bound or adhered or held thereby.

7. The crawling insect abatement matrix of claim 1, wherein the substrate comprises a foam, and the diatomaceous earth particles are incorporated in situ as one ingredient in a formulation producing the foam.

8. The crawling insect abatement matrix of claim 4, wherein the diatomaceous earth particles are added to the binder(s) in an amount from 5 to 50 percent by weight.

9. The crawling insect abatement matrix of claim 1, wherein the shaped surface has multiple peaks, projections or raised portions separated by multiple valleys or troughs therebetween.

10. The crawling insect abatement matrix of claim 9, further comprising one or more binders into which the diatomaceous earth particles are mixed, and wherein said binder is coated onto the peaks, projections or raised portions and valleys of the at least one shaped surface of the substrate.

11. A system for abating crawling insects, comprising:
a cellular, nonwoven, wet laid or other fibrous substrate with at least one shaped surface having at least one valley or trough into which diatomaceous earth particles are bound or adhered or held.

12. The system of claim 11, wherein the substrate comprises a polyurethane foam or a reticulated polyurethane foam.

13. The system of claim 12, wherein the foam has pores with pore sizes in the range of about 40 ppi to about 75 ppi.

14. The system of claim 11, further comprising one or more binders into which the diatomaceous earth particles are mixed, and wherein said binder is coated onto the at least one shaped surface of the substrate.

15. The system of claim 14, wherein the coating thickness is from 0.01 to 4 mm.

16. The system of claim 11, further comprising one or more coatings on the at least one shaped surface and to which diatomaceous earth particles are applied to be bound or adhered or held thereby.

17. The system of claim 11, wherein the substrate comprises a foam and the diatomaceous earth particles are incorporated in situ as one ingredient in a formulation producing the foam.

18. The system of claim 11, wherein the shaped surface has multiple peaks, projections or raised portions separated by multiple valleys or troughs therebetween.

19. The system of claim 14, wherein the diatomaceous earth particles are added to the binder(s) in an amount from 1 to 50 percent by weight.

20. The system of claim 11, wherein the substrate is formed into a sheet, mat, pad or tape with a top surface and a bottom surface, with the top surface being the shaped surface and the diatomaceous earth present on at least the top surface.

21. The system of claim 20, further comprising one or more adhesives on the bottom surface.

22. The system of claim 21, further comprising a release paper or film or foil covering the adhesive(s) on the bottom surface.

23. A method for abating crawling insects, comprising:
installing onto or below or near a bedding surface a cellular, nonwoven, wet laid or other fibrous substrate with at least one shaped surface having at least one valley or trough into which diatomaceous earth particles are bound or adhered or held.

24. The method of claim 23, wherein the cellular, nonwoven, wet laid or other fibrous substrate with at least one shaped surface is formed as a sheet, mat, pad or tape having the shaped surface as its top surface, and having a bottom surface, with diatomaceous earth present on at least the top surface.

25. The method of claim 24, wherein the sheet, pad, mat or tape is installed between a bedding mattress and a box spring or bedding support structure.

26. The method of claim 24, wherein the sheet, pad, mat or tape is installed between a bedding mattress and a bed pad, mattress topper or textile bed sheet.

27. The method of claim 24, wherein the sheet, pad, mat or tape is installed below a furniture article.

28. The method of claim 24, wherein the sheet, mat, pad or tape further comprises one or more adhesives on the bottom surface.

29. The method of claim 28, wherein the sheet, mat, pad or tape is applied to a surface of the bedding mattress, bed pad, mattress topper, textile bed sheet, bedding support surface, bed frame, headboard or flooring below the bedding surface.

30. A method for for abating crawling insects, comprising:
installing inside a clothing storage compartment a cellular, nonwoven, wet laid or other fibrous substrate with at least one shaped surface having at least one valley or trough into which diatomaceous earth particles are bound or adhered or held.

31. The method of claim 30, wherein the clothing storage compartment is selected from the group consisting of: luggage, duffle, wardrobe, dresser, cabinet, and drawer.
